(19) United States
(12) Patent Application Publication
(10) Pub. No.: US 2008/0117297 A1
(43) Pub. Date: May 22, 2008

(54) Covert camera apparatus for a doorframe and method

(76) Inventor: David J. Torres, Plano, TX (US)

Correspondence Address: George R. Schultz;Schultz & Associates, P.C., One Lincoln Centre, Suite 1200, 5400 LBJ Freeway, Dallas, TX, 75240, US

(21) Appl. No.: 11/602,661

(22) Filed: Nov. 21, 2006

(51) Int. Cl. H04N 7/18

(52) U.S. Cl. 348/151; 348/E07.085

(57) ABSTRACT

The invention disclosed provides an apparatus and method for a doorframe mounted covert video surveillance system. The surveillance system can be implemented in any location where monitoring passage through a door is desired. The invention allows for the quick adjustment of camera angle or the removal of the camera frame assembly, supplies a solution for video distorting caused by ground looping, and can provide a video signal to devices which record, store, or transmit images via RF to a monitor in a remote location. The apparatus includes a mounting bracket, a camera frame assembly, a non-conducting rubber-like grommet, a miniaturized camera, shock absorbing functionality, and a decoy plastic faceplate including a card reader or biometrics reader. The mounting bracket can be mounted on, in, or near a doorframe or similar structure without substantial modification to the doorframe or structure. The camera frame and mounting bracket are assembled together to allow easy adjustment of the camera angle through an arc path of up to 120° without dismantling the camera frame assembly.

### FIELD OF THE INVENTION

This invention relates to an apparatus for covert surveillance. In particular, this invention relates to an apparatus and method for mounting a miniaturized camera in, on or near a doorframe and orienting the apparatus for conducting covert camera surveillance.

### BACKGROUND OF THE INVENTION

Currently there are many video surveillance devices in the marketplace that monitor given areas or situations. Some surveillance systems attempt to be discreet and hide their image capturing functionality and others are in plain sight in an effort to deter unwanted activity in the first place. Whether or not a camera is hidden, an essential function of a video surveillance system is to capture clear images of the subjects being monitored. Often the image captured is used to identify a perpetrator, and therefore the best image possible and from the most beneficial vantage point is of utmost importance.

Prior art efforts to discreetly monitor an area include miniaturizing a camera and positioning it in ordinary fixtures such as mannequins, light fixtures, clocks, smoke detectors, or door knobs. U.S. Pat. No. 6,554,499 to Gumpenburger discloses a miniaturized camera affixed to a height measurement strip mounted to the wall or doorframe near the exit of a convenience store. One problem with this system and the other prior art systems is that they lack the capability to easily adjust and fine-tune the camera angle without having to dismantle the apparatus to make the adjustment. If the prior art camera angle can be adjusted without disassembling the apparatus, the adjustments are limited to minimal fixed positions.

Another problem with prior art video capture systems is the possibility of ground looping. Ground looping occurs where there is a difference in potential voltage in the ground connection path between two pieces of equipment like a camera and a video monitor. Ground looping causes video hum that is usually observed as vertically moving horizontal bars slowly rolling through the video image. Video hum can also cause video distortion or even tearing of the picture in severe cases.

Another problem with prior art video capture systems is the susceptibility to damage from sudden shocks. The prior art systems are easily damaged and would require repair or replacement if subjected to typical assailant forces. Not only is replacing a damaged video capture system expensive, but while the system is being repaired or replaced, the user is without a video capture system and thus unprotected.

As shown in FIGS. 1A and 1B, it is known in the prior art to mount a lens of a miniaturized camera in a grommet supported by a pair of offset flanges. The tolerance between the hole in the grommet and the lens is sufficiently large to allow the camera to be easily moved. Angle adjustments in the lens are made in the prior art by using a tie wire fed through wire holes in the flanges and around the camera body. The wire is twist tightened to the opposite side of the desired camera sight line. The taught wire holds the camera to the desired angle. This method of altering the camera angle has not been entirely satisfactory because it lacks precision in defining camera angle and is prone to movement if the camera is subject to impact. The use of the tie wire has also not been satisfactory because it electrically connects the body of the camera with the external frame thereby allowing for an electrical ground loop.

While the prior art offers some rudimentary ability to position camera angle, none has addressed the ground loop potential and none has the capability to withstand an impact without damage or need for adjustment.

It is then a goal of the present invention to provide a covert video surveillance system that produces high quality images.

It is another goal of the present invention to provide a covert video surveillance system that is mounted to a doorframe without substantial modifications to the existing structure.

It is another goal of the present invention to provide a covert video surveillance system, which includes a miniaturized camera mounted in a hingebly and removably mounted frame assembly.

It is another goal of the present invention to provide a covert video surveillance system, which can withstand and absorb the shock from a perpetrator's attack.

It is another goal of the present invention to provide a covert video surveillance system, which includes a camera frame assembly that has the ability to easily adjust the camera angle with durable precision and without disassembling the camera frame assembly.

It is another goal of the present invention to provide a covert video surveillance system, which prevents ground loop interference.

### SUMMARY OF INVENTION

The invention provides an apparatus and method for a doorframe mounted covert video surveillance system. The invention is designed to allow the apparatus to be easily and adjustably mounted without substantial modification to the structure of the doorframe. The camera frame assembly and mounting bracket are designed to allow simple adjustments of the camera angle without dismantling the camera frame assembly and to withstand direct impact forces intended to damage the apparatus. The camera angle can be further adjusted an additional five degrees in any direction as a result of the flexible nature of the rubber-like grommet imparting a friction gripping action on the camera. The invention also utilizes the non-conductive nature of the rubber-like grommet to insolate the camera from ground looping and protecting the image from video hum.

The apparatus includes a mounting bracket formed in a U-shape with an oblong hole of constant width on each side, two mounting holes, and a pass through hole for the video and power cords of the camera and/or any other devices. The camera frame is attached to the mounting bracket via two bolts through the oblong holes. The bolts are adjustable both by hand and by tool. The camera frame assembly is made up of the camera frame top, the camera frame bottom, the rubber-like grommet, the camera itself including a power cord and a video cable, shock absorbing dampers, and a plastic cover/faceplate. The camera frame top has a hole through its top surface flanked by two offset flanges. The rubber-like grommet is mounted in the hole on the two flanges creating a space for mounting the camera. In one embodiment, the camera is positioned inside the rubber-like grommet and held in place by friction. In another embodiment, threaded adjustments are provided. The camera frame bottom fits inside the camera frame top and is attached with four screws through the sides of each. In another embodiment, shock absorbing dampers are located inside the camera frame assembly and are attached to the plastic cover/faceplate and the camera frame bottom. The plastic faceplate is attached to the dampers by two flat head screws and is transparent directly over the lens of the camera. The faceplate not only serves to protect the camera lens, but also to conceal the apparatus. The faceplate helps disguise the apparatus by resembling an EXIT sign, CAUTION sign, STEP sign, or other message appropriate for the situation requiring the covert surveillance.

### BRIEF DESCRIPTION OF THE DRAWINGS

In the detailed description of the preferred embodiments presented below, reference is made to the accompanying drawings.

FIG. 1A is a top view showing a Prior Art video camera supported by a grommet and secured by wire mounted on flanges.

FIG. 1B is a sectional side view of Prior Art taken along line 1B-1B of FIG. 1A showing camera angle adjustments via wire.

FIG. 2 is a perspective view of an assembled covert camera apparatus.

FIG. 3 is a perspective view of the components of a covert camera apparatus.

FIG. 4 is a sectional plan view of camera frame assembly showing shock absorbing dampers.

FIG. 5A is a plan view of an assembled covert camera apparatus depicting the camera's sight line perpendicular to the mounting surface.

FIG. 5B is a plan view of an assembled covert camera apparatus depicting the camera's sight line adjusted 60° from center.

FIG. 6A is a plan view of a camera frame top.

FIG. 6B is a plan view of an alternate embodiment of a camera frame top.

FIG. 7 is vertical sectional view taken along line 7-7 of FIG. 6A depicting the adjustable positioning of a camera in a close tolerance flexible grommet.

FIG. 8 is a sectional view taken along 7-7 of FIG. 6A depicting how camera sight line may be adjusted.

FIG. 9 is a perspective view of an alternate embodiment of an assembled covert camera apparatus including a magnetic card reader.

FIG. 10 is a sectional plan view of camera frame assembly showing closed cell plastic shock absorbing foam.

FIG. 11 is a sectional plan view of camera frame assembly showing shock absorbing rubber washers.

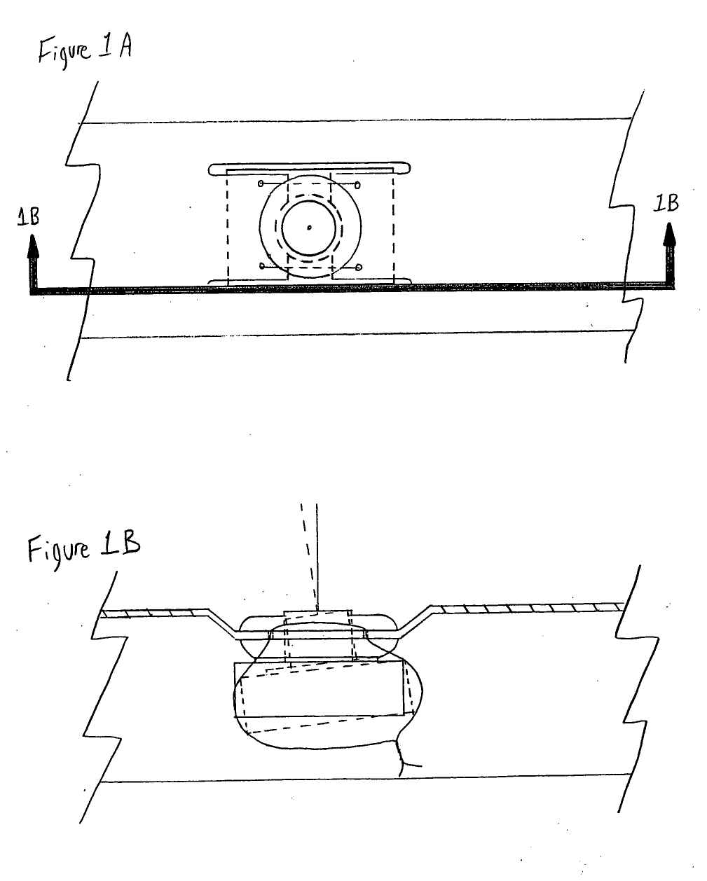

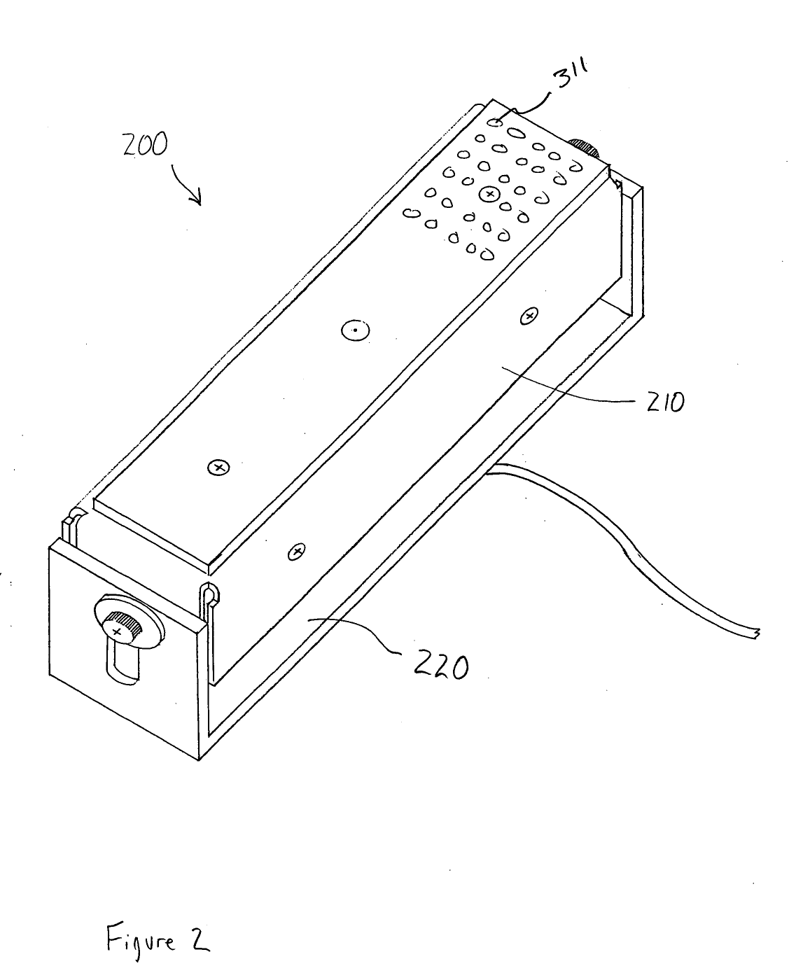

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

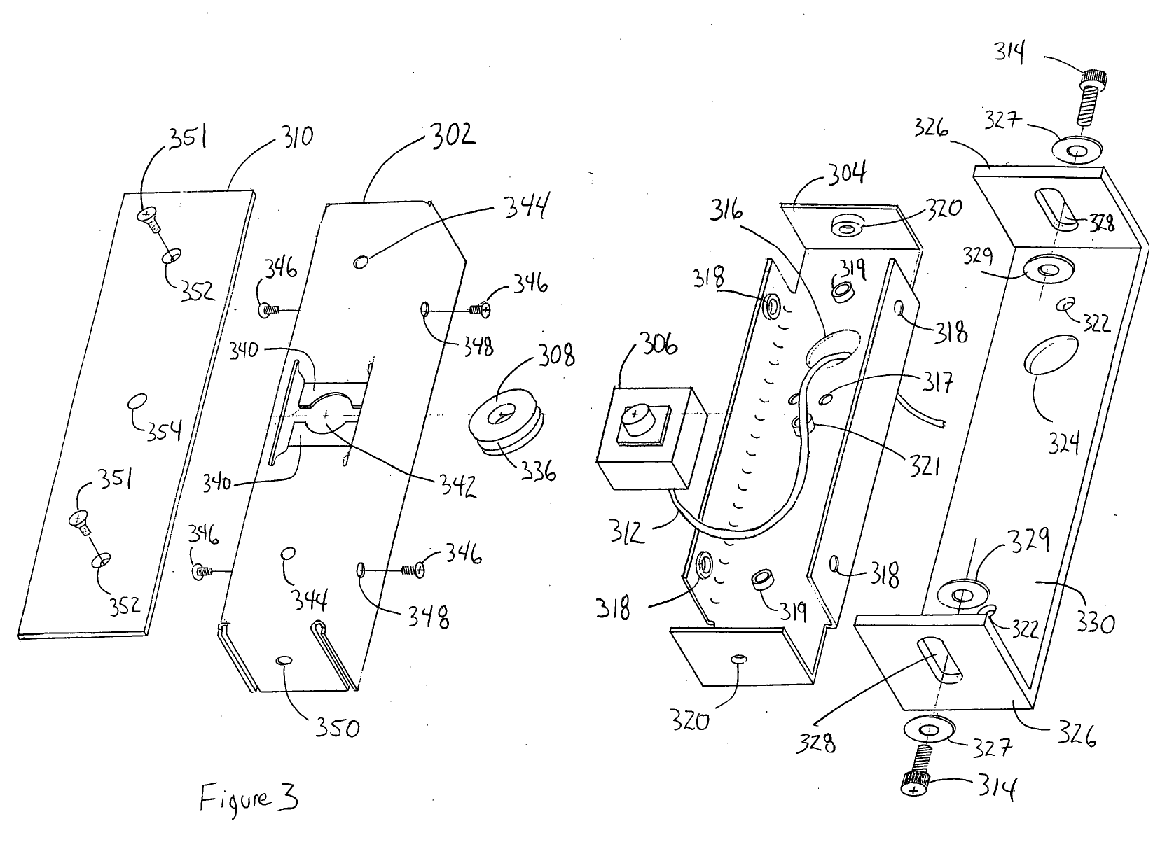

FIG. 2 shows covert camera apparatus 200 is comprised of camera frame assembly 210 and mounting bracket 220. Covert camera apparatus 200 is mounted on a doorframe anywhere surveillance is required. The apparatus is mounted over the door or beside the door and the camera angle is easily adjusted to ensure the most advantageous camera sight line. Covert camera apparatus 200 is compact and light to facilitate mounting discreetly and without substantial modifications to the doorframe. In the preferred embodiment, mounting bracket 220 is formed in the shape of a U and is made of ⅛ in. thick metal such as steel or aluminum but in other embodiments, could be made of plastic.

FIG. 3 shows mounting bracket 220 is comprised of mounting bracket base 330 and two mounting bracket sides 326. In the preferred embodiment mounting bracket base 330 is approximately 6¼ inches long. Two mounting bracket sides 326 are perpendicular to mounting bracket base 330 and are approximately 1¼ inches long. Mounting bracket base 330 has two mounting holes 322 located along its lengthwise centerline and approximately 1 inch from each mounting bracket side 326. In the preferred embodiment, mounting holes 322 are ⅛ inch in diameter, but can be any size sufficient to receive mounting screws (not shown) capable of securely supporting mounting bracket 220 and camera frame assembly 210. Mounting bracket base 330 also has pass-through hole 324 where power cord and video cable 312 of camera 306 can pass through on the way to a power source and a video receiving device. Camera 306 can provide a video feed for many different devices capable of displaying, recording, storing, or transmitting images via RF to a monitor in a remote location. In the preferred embodiment, pass through hole 324 is approximately ¾ inch in diameter and is located along the lengthwise center line of mounting bracket base 330 and approximately 1¼ inch from mounting bracket side 326 but can be located anywhere on mounting bracket base 330 that facilitates the pass through of power cord and video cable 312. Mounting bracket sides 326 each have one hinge hole 328. Each hinge hole 328 is an oblong hole of constant width located on the lengthwise centerline of each mounting bracket side 326 and in the preferred embodiment is approximately ¾ inch long and ¼ inch wide beginning approximately 3/16 inch from the open end of mounting bracket side 326. Bolt 314 and two washers are used to secure camera frame assembly 210 to mounting bracket 220 through each hinge hole 328. Washer 327 is a standard metal washer and is used on the outside surface of mounting bracket side 326. Rubber washer 329 is made of rubber or similar shock absorbing material and is used on the inside surface of mounting bracket side 326. In addition to a standard tool interface, bolt 314 is capable of being tightened or loosened by hand without the use of tools via an enlarged head with non-slip serrations. This manual capability aids the adjustable and removable functionality of camera frame assembly 210. Camera frame assembly 210 houses camera 306 and determines the sight line of camera 306. Camera frame assembly 210 and therefore the camera angle can be easily adjusted by loosening bolts 314 and rotating camera frame assembly 210 along the center axis of bolts 314. A full 120 degrees of camera angle rotation can be achieved in this manner. Additionally, camera frame assembly 210 can be adjusted laterally by loosening bolt 314 and sliding camera frame assembly 210 along the length of the oblong shape of hinge hole 328 on one side or the other.

FIG. 3 also shows the components of camera frame assembly 210 as camera frame top 302, camera frame bottom 304, camera 306 including power cord and video cable 312, grommet 308, and faceplate 310. Camera frame top 302 and camera frame bottom 304 are both formed in the shape of five sided oblong boxes.

The base surface of camera frame bottom 304 has cable hole 316 and damper holders 319 and 321. Cable hole 316 is approximately ¾ inch in diameter and located such that when camera frame bottom 304 is secured adjacent to mounting bracket 220, cable hole 316 is concentrically aligned with pass through hole 324 located on mounting bracket base 330. Thus the placement of cable hole 316 depends on the location of pass through hole 324 and vice versa. Damper holders 319 and 321 are located such that when camera frame bottom 304 and camera frame top are secured together, damper holders 319 are concentrically aligned with faceplate holes 344 and damper holder 321 is concentrically aligned with camera hole 342. In the preferred embodiment, damper holders 319 and 321 are threaded to receive a damper base bolt. The base surface of camera frame bottom 304 also has two tie-down holes 317. Tie-down holes 317 are used to secure power cord and video cable 312 to the base surface of camera frame bottom 304. In the preferred embodiment, tie-down holes 317 are located approximately ½ inch from each other and within approximately ½ inch from cable hole 316. A cable tie (not shown) or other securing means is strung through the two tie-down holes 317 and over power cord and video cable 312 securing power cord and video cable 312 to camera frame bottom 304. Perpendicular to the base surface of camera frame bottom 304 are four side surfaces forming the sides of the oblong box shape. In the preferred embodiment, the overall length of camera frame bottom 304 is approximately 5⅞ inch. The two major sides of camera frame bottom 304 are approximately 4½ inch long and are centered along the length leaving approximately ⅝ inch open space on each end between them and the minor sides. In the preferred embodiment, the overall width of camera frame bottom 304 is 1⅝ inch. The two minor sides of camera frame bottom 304 are approximately 1⅜ inch wide and are centered along the width leaving approximately ⅛ inch open space on each end between them and the major sides. Each major side has two frame bottom assembly holes 318 and both minor sides have one frame bottom bolt hole 320. Frame bottom assembly holes 318 are both approximately located on the lengthwise centerline of the major sides and ½ inch from the sides of the major sides. One frame bottom bolt hole 320 is located in the approximate middle of each minor side. Frame bottom bolt holes 320 are threaded to receive bolt 314 and frame bottom assembly holes 318 are threaded to receive assembly screws 346.

In the preferred embodiment, camera 306 is a miniaturized color charge-coupled device camera approximately 1⅛ inch wide, 1⅛ inch long, and ¾ inch tall. The cylindrical portion of camera 306 that houses the lens is approximately ½ inch in diameter. The cylindrical portion of camera 306 fits snugly into a centered circular hole approximately ½ inch in diameter in grommet 308. In the preferred embodiment, grommet 308 is a circular shape with an approximate diameter of 1 inch, is approximately ¼ inch thick, and is made of rubber. The rubber material not only helps absorb sudden shocks that may be applied to covert camera apparatus 200 but also insolates camera 306 from possible ground loop problems. Recess 336 surrounds grommet 308 at grommet's 308 vertical midpoint. In the preferred embodiment, recess 336 is approximately ⅛ inch deep all the way around grommet 308 and 1/16 inch thick. Grommet 308 can be made of any rubber-like material that is non-conductive and flexible and can also be square or rectangular in shape. Because grommet 308 is made of a non-conductive material, grommet 308 will prevent the possibility of ground looping. Ground looping occurs where there is a difference in potential voltage in the ground connection path between two pieces of equipment like a camera and a video monitor. The ground potential of the system and the doorframe can be different. Grommet 308 provides insulation from camera frame assembly 210. Ground looping causes the video image to be poor. Grommet 308 holds camera 306 securely in place using friction and is attached to camera frame top 302 by inserting offset mounting flanges 340 into recess 336. The inside diameter of the hole in the grommet is approximately 1 mm smaller than the outside diameter of the camera lens. The smaller diameter of the hole in the grommet is an advance over the art because it facilitates a stable support for the camera lenses by frictional engagement. The flexibility of grommet 308 allows for minor camera angle adjustments up to approximately five degrees in any direction. To adjust the camera angle, the cylindrical portion of camera 306 is slightly repositioned in the center hole of grommet 308.

In the preferred embodiment, camera frame top 302 and camera frame bottom 304 are made of the same material as mounting bracket 220 but approximately 1/16 inch thick. The top surface of camera frame top 302 has faceplate holes 344 and camera hole 342 flanked by two offset mounting flanges 340. In one embodiment, camera hole 342 and mounting flanges 340 are located in the center of camera frame top 302. In another embodiment, camera hole 342 flanked by mounting flanges 340 is located off center to accommodate additional devices such as a card reader. Camera hole 342 and mounting flanges 340 are offset below the top surface of camera frame top 302 approximately ⅛ inch. Perpendicular to the top surface of camera frame top 302 are four side surfaces forming the sides of the oblong box shape. In the preferred embodiment, the overall length of camera frame top 302 is approximately 6 inches. The two major sides of camera frame top 302 run the length of camera frame top and are therefore approximately 6 inches in length also. In the preferred embodiment, the overall width of camera frame top 302 is 1¾ inch. The two minor sides of camera frame top 302 are approximately 1½ inch wide and are centered along the width leaving approximately ⅛ inch open space on each end between them and the major sides. Each major side has two frame top assembly holes 348 and both minor sides have one frame top bolt hole 350. All frame top assembly holes 348 are approximately located on the lengthwise centerline of the major sides and 1¼ inch from the ends of the minor sides. One frame top bolt hole 350 is located in the approximate middle of each minor side. The overall dimensions of camera frame top 302 are slightly larger than those of camera frame bottom 304. When assembled, camera frame bottom 304 fits inside of camera frame top 302.

In the preferred embodiment, faceplate 310 is approximately 5¾ inches in length and 1½ inches wide. Faceplate 310 is made of a transparent, unbreakable plastic and is approximately 1/16 inch thick. The underside of faceplate 310 is to be coated flat black except for lens hole 354. Faceplate 310 has two faceplate mounting holes 352 and lens hole 354. Faceplate mounting holes are also used to hold in place dampers 402. Lens hole 354 is not a hole through the material; rather lens hole 354 is a small circular transparent area that allows camera 306 to capture images through faceplate 310. In the preferred embodiment, the diameter of lens hole 354 is approximately ¼ inch and the top surface of faceplate 310 is dark in color with no writing. In other embodiments, to employ covert tactics, faceplate 310 can be designed to resemble an EXIT sign, CAUTION sign, or any number of messages. Electrical light emitting diodes 311 can be embedded in faceplate 310 and programmed to scroll signs or banners across its surface. Faceplate 310 is attached to camera frame top 302 and dampers 402 with two flathead faceplate screws 351. Faceplate mounting holes 352 are countersink holes to allow faceplate screws 351 to sit flush with faceplate 310.

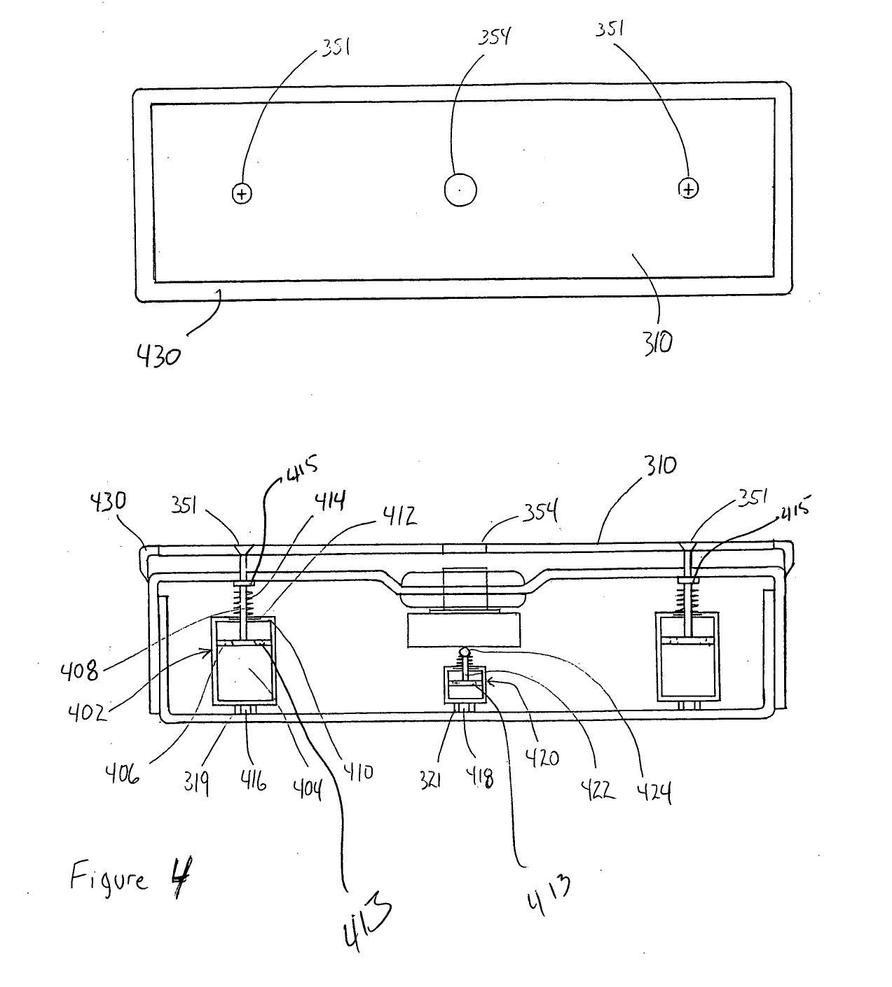

FIG. 4 shows shock absorbing fluid dampers 402 mounted inside camera frame assembly 210. Damper 402 includes cylinder 404 in which piston 406 is displaceable. Piston 406 sits at the end of piston rod 408 which projects through end-wall 410. Holes 413 within the piston head allow for fluid to move from one end of the cylinder to the other. Seal 412, which seals off piston rod 408, is provided in end-wall 410. Stop ring 415 is provided to prevent removal of the faceplate by prying. Spring 414 is positioned around piston rod 408 in between the top surface of chamber 404 and bottom surface of camera frame top 302. Spring 414 can also be housed inside chamber 404. The piston is displaced by impact to the faceplate. After displacement, spring 414 moves piston 406 back into its original position. Dampers 402 are secured to the bottom surface of camera frame top 302 by faceplate screws 351. The bottom end of dampers 402 are held in position by inserting damper base bolts 416 into damper holders 319 located on camera frame bottom 304. An additional damper 420 is positioned under camera 306. Damper 420 is held in place by inserting damper base bolt 418 into damper holder 321 located under camera 306. Piston rod 422 is held in place by and contacts the bottom surface of camera 306 via piston ball 424 located on the end of piston rod 422. Piston ball 424 is a non-metallic substance in the preferred embodiment to prevent electrical connection of the piston with the camera body. The piston ball is positioned to deflect downwardly and slide along the bottom of the camera. The piston ball is configured to also allow the camera bottom to pivot without losing contact. Dampers 402 and 420 can absorb the shock applied directly to faceplate 310 by those attempting to damage the unit or by sudden impacts received purely by accident.

FIG. 4 also shows faceplate skirt 430. Faceplate skirt 430 is made of rubber or plastic and is attached along the circumference of faceplate 310. Faceplate skirt 430 is used to conceal the space between the bottom surface of faceplate 310 and the top surface of camera frame top 302 when dampers 402 and 420 are in their resting positions. Faceplate skirt 430 can also be adapted to serve as a weather seal for outdoor use.

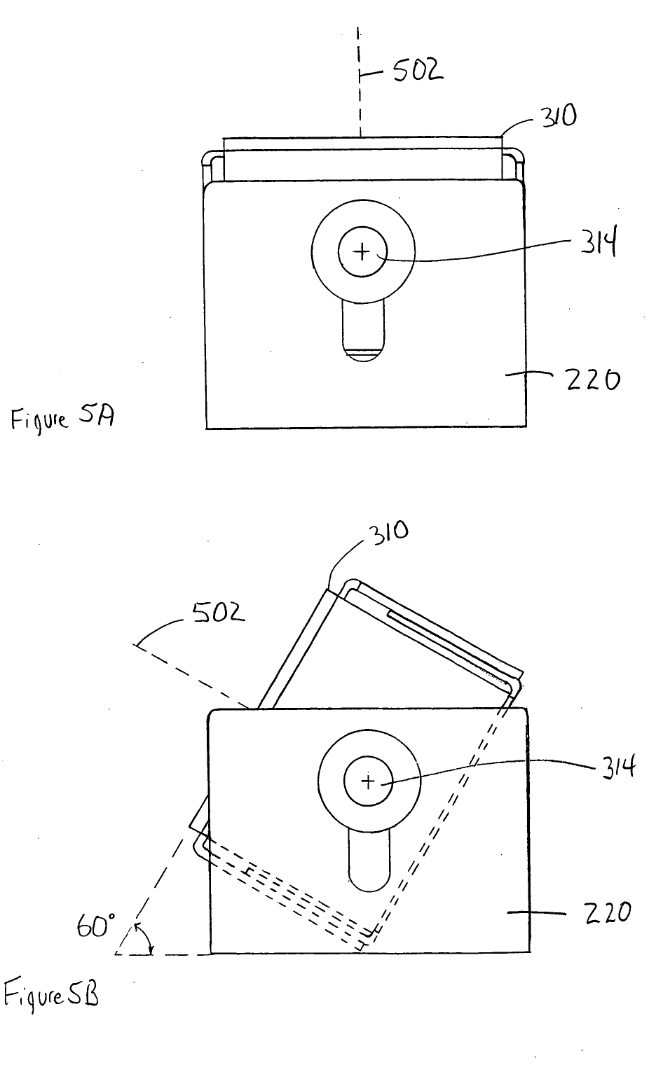

FIGS. 5A and 5B show a side view of the present invention assembled. FIG. 5A depicts the orientation of camera frame assembly 210 as parallel to mounting bracket 220. In this configuration, camera sight line 502 is perpendicular to faceplate 310 and to mounting bracket 220. FIG. 5B depicts the orientation of camera frame assembly 210 rotated along the central axis of bolts 314 sixty degrees from center. The present invention is capable of adjusting the orientation of camera frame assembly through any angle between zero degrees and sixty degrees either direction for a range of motion equal to 120 degrees. To adjust the camera sight line angle, loosen bolts 314 on each end of covert camera apparatus 200 and rotate camera frame assembly along the central axis of bolts 314. When desired angle is reached tighten bolts 314 by hand or with a tool.

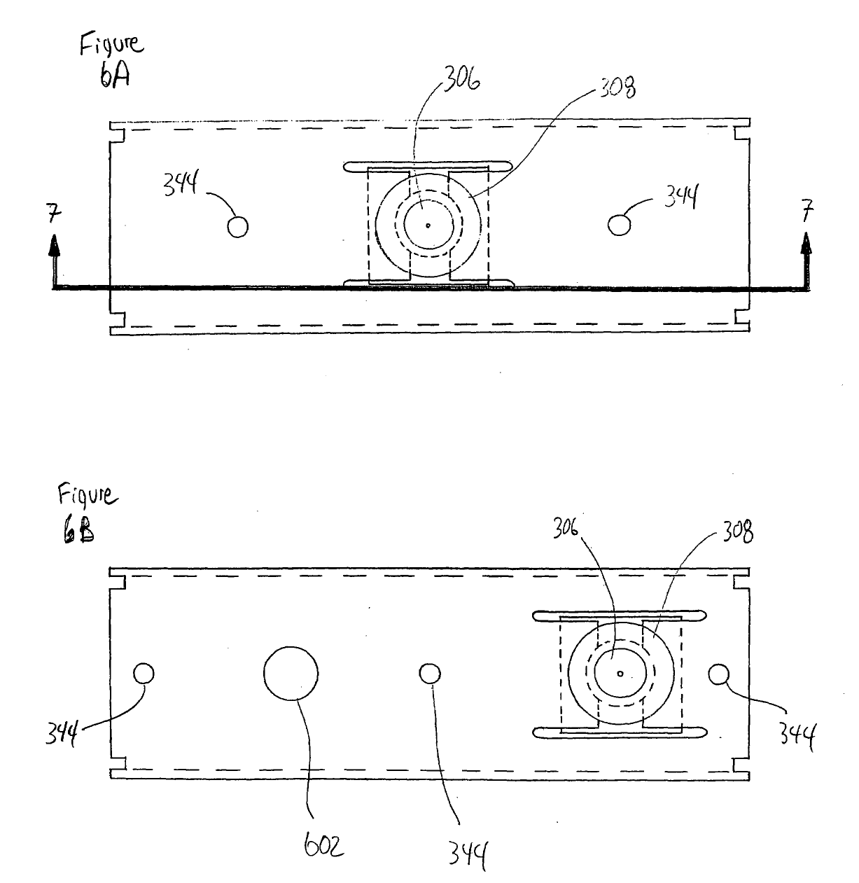

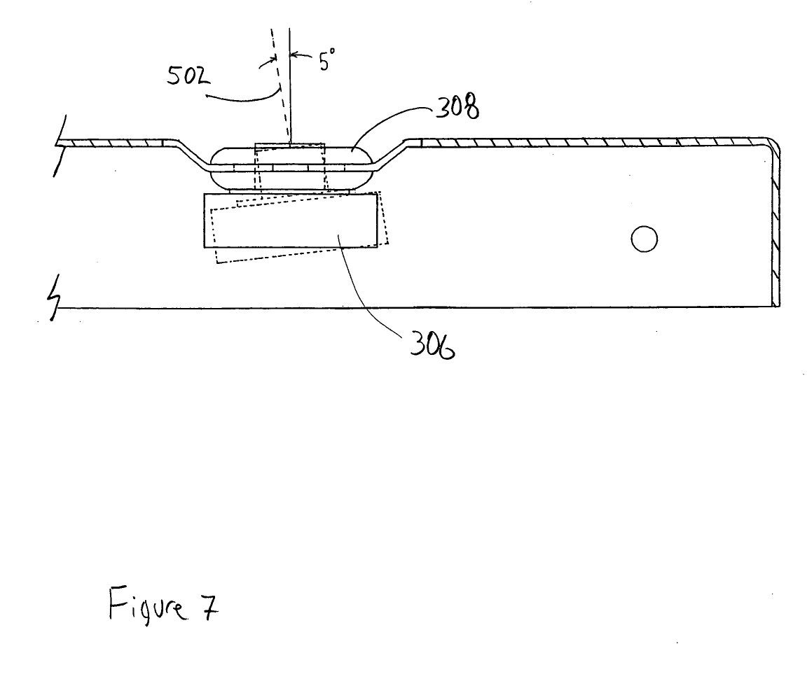

FIG. 6A shows a top view of camera frame top 302 with grommet 308 and camera 306 in place. FIG. 6B shows a top view of another embodiment of camera frame top 302 including device pass-through hole 602 and additional faceplate holes 344. Device pass-through hole 602 is located behind where the additional device (not shown) would be mounted and is sized appropriately to allow the pass-through of the necessary cables and power cords connected to the device. Accordingly, the locations of camera hole 342, mounting flanges 340, and faceplate holes 344 are adjusted as shown to accommodate the additional device.

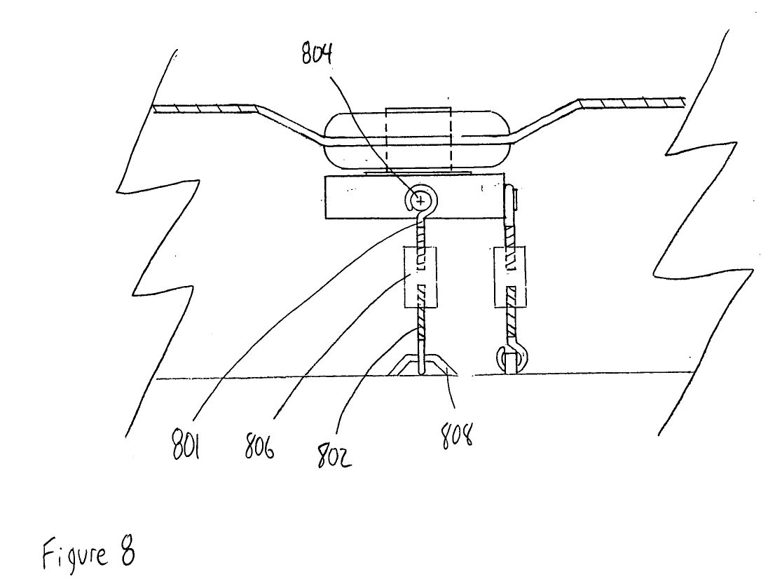

FIG. 7 is a sectional view taken along line 7-7 of FIG. 6A depicting camera sight line 502 adjusted an additional approximate five degrees. The flexible nature of grommet 308 allows camera 306 to be slightly adjusted in any direction while seated in grommet 308.

FIG. 8 is a magnified sectional view taken along 7-7 of FIG. 6A depicting how camera sight line 502 may be adjusted while seated in grommet 308. A set of two adjusting means are provided which accurately and rigidly fix the angle of the camera in the grommet. The adjusting means can be used with or without the spring damper mechanisms. Two adjusting means are each comprised of a pivot point screw 804 and 814; a pair of oppositely threaded eyelet bolts 801 and 802, and 811 and 812; a threaded collar 806 and 816; and a tab 808 and 818. Pivot point screw 804 attaches threaded eyelet bolt 801 to one side of camera 306. Pivot point screw 814 attaches threaded eyelet bolt 811 to an adjacent side of camera 306. The threaded end of eyelet bolts 801 and 811 are inserted into threaded collars 806 and 816 respectively. Eyelet bolts 802 and 812 are inserted into the other ends of collars 806 and 816 respectively and are further attached to camera frame bottom 304 through tabs 808 and 818 respectively. Varying the overall length of each adjusting means tilts camera 306 while seated in grommet 308. The length of each adjusting means is increased or decreased by rotating collar 806. Each pair of eyelet bolts is threaded opposite to each other. Accordingly, rotating collar 806 either forces both eyelets out of collar 806 thus increasing the length of the adjusting means, or forces both eyelets into collar 806 thus decreasing the length of the adjusting means. The combination of the two adjusting means perpendicularly related to each other located on adjacent sides of camera 306 allows camera angle 502 to be adjusted up to approximately five degrees in any direction. The eyelet bolts, threaded collars, and tabs can be made of plastic to prevent electrical contact between the camera and the enclosure. In an alternate embodiment, the eyelet bolts and tabs may be coated with a rubber covering to insulate them from the enclosure. In an alternate embodiment, tabs 808 and 818 may be on an internal surface of camera frame top in orthogonal positions to impart the required movement and positioning of camera 306.

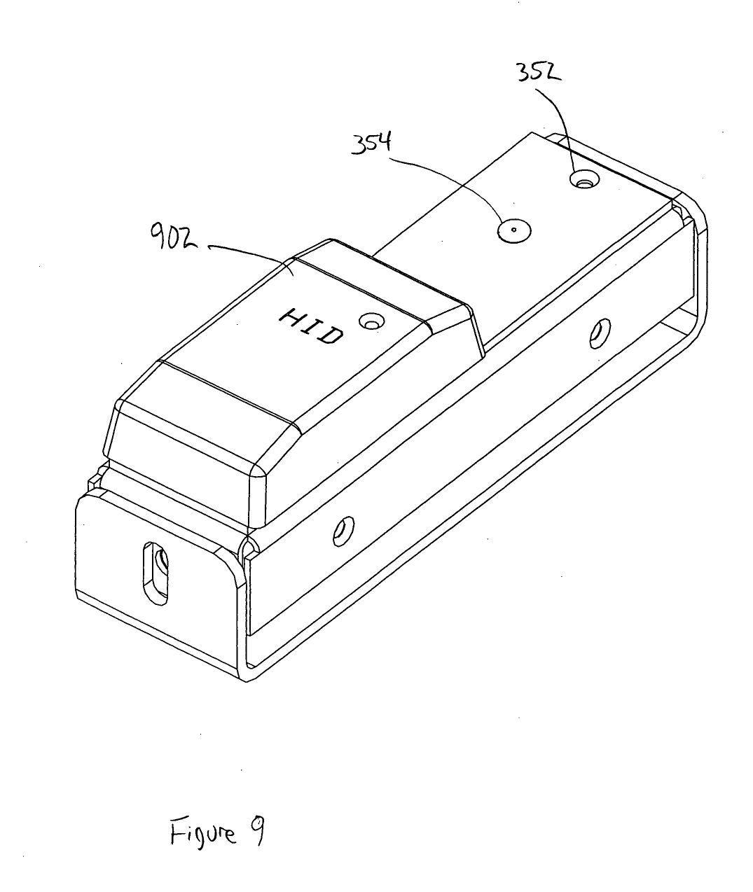

Another embodiment of the present invention is shown in FIG. 9. FIG. 9 shows the assembled apparatus including the attachment of card reader 902. Accordingly, the locations of lens hole 354 and faceplate mounting holes 352 are adjusted as shown to accommodate the addition of card reader 902. In the preferred embodiment, if faceplate 310 is enabled to send active messages, such as with a series of light emitting diodes, messages can be displayed. For example, a clock display, an “Entry Allowed” message, an “Entry Denied” message or other messages can be displayed or scrolled across the faceplate.

In additional embodiments, different security devices can be attached to the apparatus. Different devices such as thumbprint readers, iris scanners, voice recognition sensors or motion detectors can be implemented if the need arises.

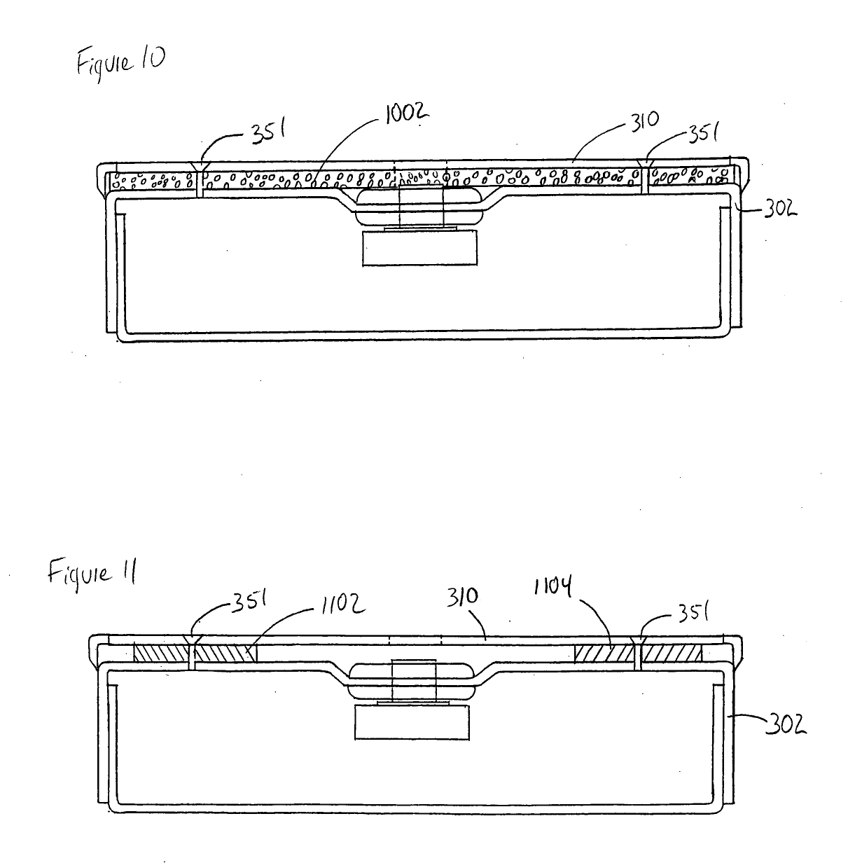

In other embodiments of the present invention such as shown in FIG. 10, closed cell plastic shock absorbing foam 1002 is secured between faceplate 310 and the top surface of camera frame top 302. In still other embodiments as shown in FIG. 11, shock absorbing rubber washers 1102 and 1104 are secured by faceplate screws 351 and located between faceplate 310 and the top surface of camera frame top 302. The foam and washers may be used in any embodiment of the invention to add additional impact resistance and weather resistance.

The preferred method of use of the present invention requires the steps of first attaching mounting bracket 220 in a desired location. The location can be anywhere in, on, or around the doorframe that will provide an advantageous camera sight line and still be discreet. The easily adjustable nature of covert camera apparatus 200 allows the option of numerous locations because the sight line of camera 306 can be easily corrected. After connecting the power cords and video cables to a power source and video recording or video display device, the next step is securing camera frame assembly 210 mounting bracket 220. Verifying the camera sight line on the video display source ensures the apparatus is capturing the desired field of view. Adjusting the camera angle by loosening but not removing the bolts securing camera frame assembly 210 to mounting bracket 220 and rotating camera frame assembly to the desired angle is the final step. Adjusting the camera angle by the internal adjusting means fine tunes the camera sight line.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An apparatus for video surveillance comprising:
a mounting bracket;
a camera enclosure having a circular opening and an internal surface and an external surface supported by the mounting bracket;
an opposing set of camera supports, forming a semicircular opening, rigidly fixed to the internal surface of the camera enclosure;
a rubber camera grommet having a grommet hole mounted in the semicircular opening;
a video camera having a lens extension mounted adjacent the lens opening;
the lens extension frictionally mounted in the grommet hole;
a faceplate mounted to the exterior surface by at least one shock absorbing faceplate standoff.

2. The apparatus of claim 1 where the mounting bracket is comprised of a mounting bracket base and two mounting bracket sides each having an oblong opening of constant width and each mounting bracket side rigidly connected to the mounting bracket base.

3. The apparatus of claim 1 where the grommet is comprised of an electrical insulator and flexibly secures the lens extension to the set of camera supports.

4. The apparatus of claim 1 where the shock absorbing standoff is a spring damper mechanism.

5. The apparatus of claim 4 further comprising a second spring damper mechanism supporting the video camera by a ball connector which electrically insulates the video camera from the camera enclosure.

6. The apparatus of claim 1 where the shock absorbing standoff is a sheet of closed cell plastic foam extending the length of the faceplate.

7. The apparatus of claim 1 where the shock absorbing standoff is a rubber washer.

8. The apparatus of claim 1 where the faceplate includes a window adjacent to the lens opening.

9. The apparatus of claim 1 where the faceplate includes light emitting diodes programmed to display messages.

10. The apparatus of claim 1 where the camera enclosure is pivotally mounted to the mounting bracket.

11. The apparatus of claim 1 where the adjusting means comprises two adjusting assemblies orthogonally related to each other each comprising a first threaded eyelet connected to a threaded collar, a second threaded eyelet connected to the opposing end of the collar, and a loop securing the other end of the second eyelet.

12. The apparatus of claim 1 where an identity recognition device is attached to the faceplate.

13. The apparatus of claim 12 where the identity recognition device is a card reader.

14. An apparatus for covert video surveillance comprising:
a mounting bracket;
a camera frame assembly having a camera frame top and a camera frame bottom pivotally mounted to the mounting bracket;
the camera frame top having a pair of offset flanges surrounding a camera opening;
a grommet having a recess mounted on the offset flanges;
a camera having a camera bottom, a camera body and a lens;
the lens frictionally mounted in the grommet;
a camera angle adjustment means connected to the camera body, for variable adjusting of a camera angle;
at least one shock absorbing damper attached to the camera frame bottom;
the camera frame top secured to the camera frame bottom; and
a faceplate secured to the at least one shock absorbing damper.

15. The apparatus of claim 14 where the mounting bracket is comprised of a mounting bracket base and two mounting bracket sides each having an oblong opening of constant width and each mounting bracket side rigidly connected to the mounting bracket base.

16. The apparatus of claim 14 where the grommet prevents ground looping and flexibly secures minor camera angle adjustments.

17. The apparatus of claim 14 where a plastic foam layer is secured between the faceplate and the camera frame top.

18. The apparatus of claim 14 where the faceplate includes a window adjacent to the camera.

19. The apparatus of claim 14 where the faceplate includes light emitting diodes.

20. The apparatus of claim 14 where the adjusting means comprises two adjusting assemblies orthogonally related to each other each comprising a first threaded eyelet connected to a threaded collar, a second threaded eyelet connected to the opposing end of the collar, and a loop securing the other end of the second eyelet.

21. The apparatus of claim 14 where a card reader is attached to the faceplate.

22. The apparatus of claim 14 further comprising a camera shock absorbing damper in pivotal and slideable contact with the camera bottom.

23. The apparatus of claim 14 wherein the at least one shock absorbing means further comprises:
a fluid filled damper cylinder containing a damper piston and a damper spring;
wherein the damper piston includes a piston rod extending out of the damper cylinder and connected to the faceplate; and,
wherein the piston rod includes a stop ring means, adjacent the camera frame top, to prevent removal of the faceplate.

24. A method of mounting a video surveillance system to the top of a bus door frame interior comprising the steps of:
providing a mounting bracket with a mounting bracket base, two mounting bracket sides, and two adjustable bolts;
providing a camera frame assembly of a camera frame top connected to a camera frame bottom;
providing a camera mounted to the camera frame assembly through a rubber grommet;
providing an orthogonal set of threaded adjustment means, connected to the camera and the camera frame assembly;
providing a faceplate covering the camera and attached to the camera frame assembly;
attaching the mounting bracket to a doorframe;
attaching the camera frame assembly to the mounting bracket with the two bolts;
orienting the camera frame assembly in the mounting bracket to the desired camera angle; and,
orienting the camera in the rubber grommet by the threaded adjustment means

25. The method of claim 24 further comprising:
providing a lighted indicator means on the faceplate;
providing a scanner on the camera frame; and,
activating the lighted indicator means upon receipt of a signal from the scanner.

26. The method of claim 24 further comprising the steps of:
providing a shock absorber between the faceplate and the camera frame assembly; and
absorbing an impact with the shock absorber.
